(19) United States
(12) Patent Application Publication
(10) Pub. No.: US 2010/0138890 A1
(43) Pub. Date: Jun. 3, 2010

(54) DEVICE TO ALLOW CONTENT ANALYSIS IN REAL TIME

(75) Inventor: Olaf Seupel, Pinnow (DE)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/598,017

(22) PCT Filed: Apr. 24, 2008
(86) PCT No.: PCT/IB08/51570

§ 371 Date: Oct. 28, 2009

(30) Foreign Application Priority Data
May 7, 2007 (EP) 07107646.7

(51) Int. Cl. H04N 7/173

(52) U.S. Cl. 725/131

(57) ABSTRACT

The invention relates to an electronic device for processing input stream data including capturing, watching, digitising compressing, storing and/or analysing analogue or digital stream data consisting of at least one TV tuner and an encoder or a decoder, wherein the encoder or the decoder comprises a terminal or pin providing data of a content analysis.

### FIELD OF THE INVENTION

The invention relates to a device for transmitting data in real time to a filter to allow content analysis due to applications e.g. on a personal computer in real time.

### BACKGROUND OF THE INVENTION

Especially personal computer (PC) systems that are able to capture analogue or digital audio/video streams and that are equipped with a DVD/HDD authoring software (SW) are very often used as personal hard disk video recorder to store audio/video data on the hard disk of the personal computer.

Audio/video recording systems in a PC environment consist of many different components, that are needed to capture, display and record the analogue or digital input signals. These include hardware components such as capture devices like capture boards and memories like disk drives, and software or hardware components such as MPEG (Motion Picture Expert Group) encoders or decoders. All of these components function together, because they are implemented as so called DirectShow (Windows multimedia streaming architecture) filter.

Data streams into the filter through its input pins is modified in some way by the filter and then the modified data streams out through the output pins of the filter. The next filter picks up the data and process it or just writes them to the hard disk. The operating system like Microsoft Windows of the personal computer has to manage the set of audio/video filters and enable them to work together. Filters are connected in a filter graph that performs a particular task such as displaying video or playing audio.

US 2004/0258060 A1 discloses a system for parsing a packetized multi-program transport stream. The program specific information is extracted from the program stream and displayed on a user interface to select a program.

US 2003/0033318 A1 discloses a device for indexing multimedia data.

### OBJECT AND SUMMARY OF THE INVENTION

It is an object of the invention to create a device to allow content analysis in real time. Additionally the device should be easily achievable and inexpensive in production.

The above mentioned problems will be solved with the features of claim 1.

Therefore the problem according to the device will be solved using an electronic device for processing input stream data including capturing, watching, digitising compressing, storing and/or analysing analogue or digital stream data consisting of at least one TV (television) tuner and an encoder or a decoder, wherein the encoder or the decoder comprises a terminal or pin providing data of a content analysis.

It is advantageous that the data provided from the content analysis terminal or pin are transferred to a dump filter. According to the invention the dump filter stores the content analysis data using a memory.

### BRIEF DESCRIPTION OF THE DRAWINGS

The above and other features and advantages of the invention will be apparent from the following description of an exemplary embodiment of the invention with reference to the accompanying drawings, in which:

FIG. 1 shows a block diagram of an inventive device;

FIG. 2 shows schematic view of an encoder/multiplexer with the inventive pin or terminal;

FIG. 3 shows a block diagram of an inventive device; and

FIG. 4 shows schematic view of a decoder/multiplexer with the inventive pin or terminal.

### DESCRIPTION OF EMBODIMENTS

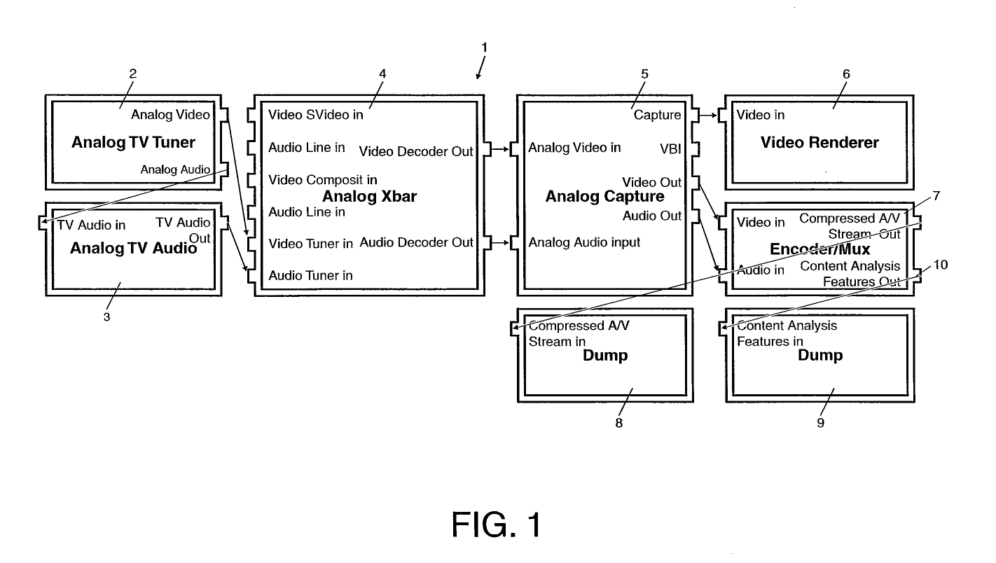

FIG. 1 shows a block diagram to explain the inventive device. The inventive device is able to process input stream data. According to a first embodiment of the invention, the device is capturing and analysing analogue audio/video streams, and according to a second embodiment the device is capturing and analysing digital audio/video streams.

FIG. 1 shows a DirectShow filter graph 1, which is able to capture, watch, digitise, compress, store and analyse analogue TV on a PC, equipped with a TV capture/encoder board and an operating system like Windows OS (operating system).

The device consists of an analogue TV tuner 2, an analogue TV audio device 3, an analogue Xbar (crossbar) device 4, an analogue capturer 5, a video renderer 6, an encoder/multiplexer 7 and dump filter 8, 9.

The data or signals are provided from one device to the following device according to the displayed arrows. Starting at the analogue TV tuner 2, an analogue audio signal is transferred to the analogue TV audio device 3 from analogue audio terminal to the TV audio in terminal. Furthermore an analogue video signal is transferred from the analogue TV tuner 2 to the analogue Xbar 4 from the analogue video output terminal to the video tuner input terminal.

A signal from TV audio out of analogue TV audio is transferred to the audio tuner in terminal of the analogue Xbar device 4. From the analogue Xbar device 4 the data are provided to the analogue capture device 5 via the video decoder output and the audio decoder output to the analogue video input and the analogue audio input.

From the analogue capture device 5 the data are supplied to the video renderer 6 from the capture output to the video input. Additionally data are supplied from the analogue capture device 5 to the encoder/multiplexer 7 from the video output terminal and the audio output terminal to the video input terminal and the audio input terminal of the encoder/multiplexer 7. The processed data from the encoder/multiplexer are provided from a compressed audio/video stream output terminal to the dump filter 8 compressed audio/video stream input terminal.

Additionally the encoder/multiplexer 7 has a terminal content analysis features output via which the data of a content analysis are supplied to the content analysis features input terminal of the dump filter device 9.

The ‘Encoder/Multiplexer’ DirectShow filter 7 is extended with the proposed content analysis feature pin or terminal. The filter graph of FIG. 1 is also extended with a second dump filter 9 to store the delivered content analysis features.

Therefore the FIG. 1 displays a DirectShow filter graph providing content analysis features in real time out of an analogue audio/video input stream, which is captured, compressed and stored on the PC hard disk or an other device to save the data.

Content analysis features are delivered in real time as a separate stream from the capture card IC (integrated circuit) site preferably including an encoder into the PC site. These features can be read via the new proposed content analysis feature output pin or terminal 10 at the DirectShow ‘Encoder/Multiplexer’ filter 7. The output pin or terminal is connected to a DirectShow ‘Dump’ filter 9, which writes the content analysis features in a separate file to the hard disk. This file includes preferably the audio and video content analysis features of at least some or all encoded frames together with the corresponding time stamps of the compressed audio/video stream, and it provides the relevant or all information necessary to build up content analysis applications in real time. Because of the fact, that the content analysis features are available during recording a second post processing pass of the recorded stream—to analyze the stream—can preferably prevented.

Content acquisition of analogue video streams includes the extraction of content descriptors in the pixel domain and/or the extraction of encoding statistics. Content acquisition of analogue audio streams includes the extraction of content descriptors in the PCM (pulse code modulation) domain and/or the extraction of encoding statistics. These parameters are used to calculate content analysis features, which are available at the new proposed Content Analysis Feature output pin or terminal 10.

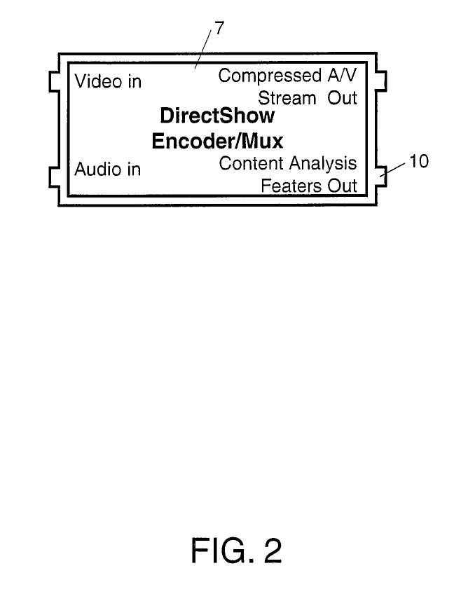

FIG. 2 shows schematically the encoder DirectShow encoder/multiplexer filter 7 with Content Analysis Feature Pin or terminal 10. Besides the video input and audio input terminals and the compressed audio/video stream output terminal an additional output pin 10, so called content analysis features output terminal has to be inserted to provide an access to the content analysis features, generated in the encoder.

Since all the content analysis features are generated in the encoder the inventive pin or terminal has preferably to be placed at this filter 7.

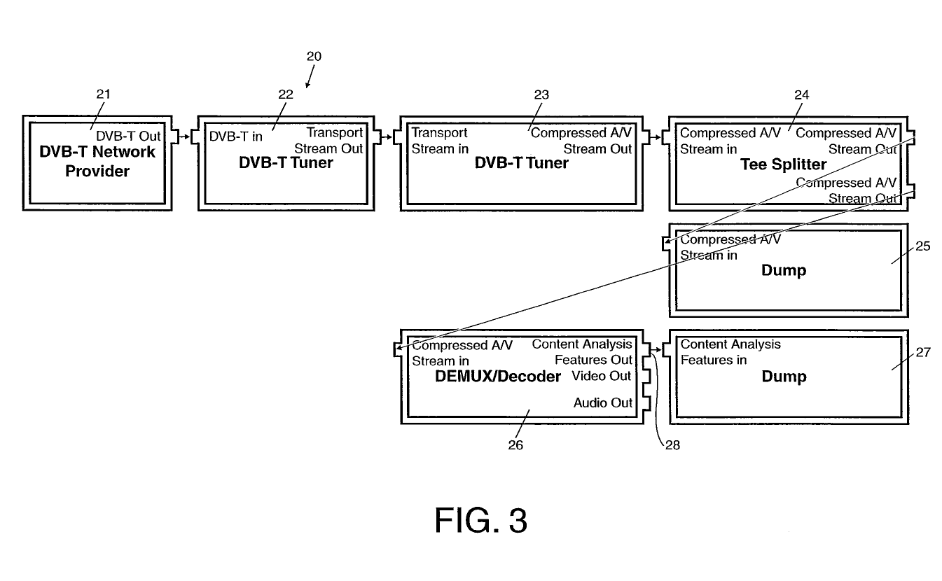

FIG. 3 displays a DirectShow filter graph 20, which is able to capture, store and analyse digital TV data on a PC, equipped with a TV capture board and an operating system like Windows OS.

Starting at a DVB-T network provider 21 this provider 21 supplies data to a DVB-T tuner 22 via the DVB-T output to the DVB-T input of the tuner 22. The tuner 22 supplies data via the transport stream output to the transport stream input of a digital capture device 23. The digital capture device 23 provides processed data via the compressed audio/video stream output terminal to the compressed audio/video stream input terminal of the tee splitter 24. The tee splitter has two output terminals as compressed audio/video stream outputs. The first output provides data to the compressed audio/video input terminal of the dump filter 25. The second output of device 24 supplies data to the compressed audio/video stream input terminal of the demultiplexer/decoder device 26. This demultiplexer/decoder device 26 has a content analysis features output pin or terminal 28 providing content analysis features data to the dump filter device 27.

FIG. 3 displays a modified ‘Demultiplexer/Decoder’ DirectShow filter, which is extended with the inventive content analysis feature pin or terminal 28. The filter graph is also extended with a second dump filter 27 to store the delivered content analysis features e.g. on a hard disk.

Comparable with the capturing of analogue streams the content analysis features are delivered in real time as a separate stream from the capture card IC site including a demultiplexer and decoder into the PC site.

This feature makes the content analysis features available during recording and preferable a second post processing pass of the recorded stream is not necessary.

Content acquisition of digital video streams includes the decoding of the compressed stream, followed by the extraction of content descriptors in the pixel domain and/or the delivery of coding statistics. Content acquisition of digital audio streams includes the decoding of the compressed stream, followed by the extraction of content descriptors in the PCM domain and/or the delivery of coding statistics. These parameters are used to calculate content analysis features.

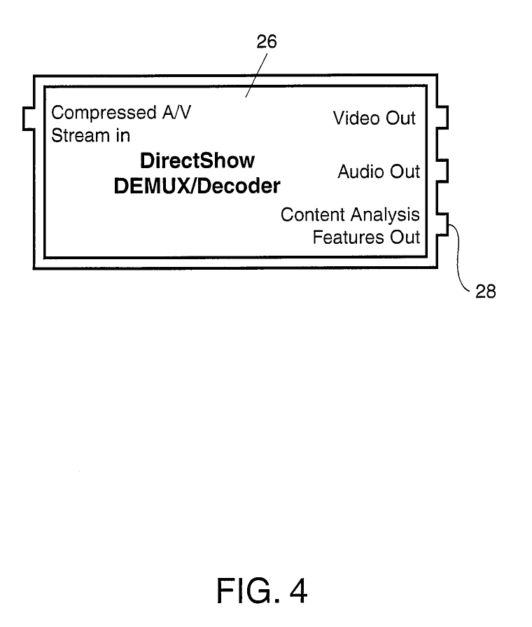

FIG. 4 shows in detail the DirectShow “Demultiplexer/Decoder” filter 26. An additional output pin ‘Content Analysis Features Output’ 28 has been inserted to provide an access to the content analysis features, generated in the decoder.

Since all the content analysis features are generated in the decoder this pin 28 has been placed at this filter 26.

According to the function of the inventive device, the personal computer (PC) captures an analogue or digital audio/video stream via e.g. a capture card and stores the compressed stream to the hard disk. Content acquisition in real time is done in the encoder 7, 26 respectively the decoder 26. During recording content parameters are extracted. These parameters are used to calculate content analysis features, which describe the scene contents. Based on these content analysis features several higher-level content analysis applications can be built.

The content analysis features are available via the inventive content analysis feature pin or terminal 10, 28 at the encoder 7 respectively decoder 26 DirectShow filter. This pin or terminal 10, 28 has been placed into a DirectShow filter 7, 26 in dependency of the captured audio/video stream. In case of an analogue stream, the pin 10 has been placed into the DirectShow encoder filter. In case of a digital stream, the pin has been placed into the DirectShow decoder filter 26.

In the above 2 scenarios the proposed content analysis feature pin or terminal 10, 28 was placed into the ‘Encoder/Multiplexer’ and ‘De-multiplexer/Decoder’ DirectShow filter 7, 26. There are other possibilities to place this pin or terminal. In dependency of the overall system software or hardware architecture the content analysis feature pin or terminal could also be placed in another filter.

Advantageously the content analysis features are made available in real time at an output pin of a DirectShow filter.

The invention can be applied in personal computers or other computers which are at least partly used as personal audio/video recorder.

A content source can be any kind of uncompressed analogue or digital audio/video streams, e.g. analogue cable TV or satellite tuner signal, film material used for DVD recording, DV camcorder input signals, etc.

In case of analogue input streams the recording system includes an encoder sub-system, which compresses the analogue audio/video input stream, stores the compressed stream at the disk and extracts content analysis features at the same time. The kind of compression is independent—it could be MPEG, Windows Media, etc.

In case of digital input streams the recording system stores the compressed stream at a memory like a disk. The system also includes a decoder sub-system, which decompresses the digital input stream irrespective of the kind of compression to extract content analysis features at the same time.

The system stores the compressed stream on a DVD (Digital Versatile Disc), HDD (hard disk) or any other storage medium. In parallel the content analysis component processes the content analysis feature stream and calculates content analysis application features, which are synchronized to the recorded stream by using of timestamps. As soon as the recording stops a content analysis feature list with all features is available and will be stored separately to the recorded stream.

The system could also be extended with a High-level content analysis filter, that evaluates the content analysis features and provides certain audio/video stream events (like commercial start, semantic scene change, . . . ) in real time, which are needed and defined by the user application. These stream events are stored separately to the recorded stream. In this case the list of content analysis features must not be stored.

### REFERENCES

1 graph

2 TV tuner

3 TV audio device

4 Xbar device

5 analogue capturer

6 video renderer

7 encoder/multiplexer

8 dump filter

9 dump filter

10 pin or terminal

20 graph

21 network provider

22 tuner

23 capture device

24 tee splitter

25 dump filter

26 encoder/multiplexer

27 dump filter

28 terminal

1. Electronic device for processing input stream data by at least one of capturing, watching, digitising compressing, storing and analysing at least one of analogue and digital stream data, comprising:
at least one TV tuner; and
at least one of an encoder and a decoder,
wherein the at least one of the encoder and the decoder comprises at least one of a terminal and a pin providing data of a content analysis.

2. Device according to claim 1, wherein the data provided from the at least one of the content analysis terminal and the pin are transferred to at least one of a dump filter and a High-level content analysis filter.

3. Device according to claim 2, characterised in that the dump filter stores the content analysis data using a memory.

4. Device according-to claim 2, characterised in that the High-level content analysis filter stores an audio/video stream event data using a memory.
